(19) United States
(12) Patent Application Publication
(10) Pub. No.: US 2014/0051322 A1
(43) Pub. Date: Feb. 20, 2014

(54) GAME CALL EXTENSION APPARATUS AND METHOD

(71) Applicant: Wildgame Innovations, LLC, Broussard, LA (US)

(72) Inventor: David Lynn Jackson, Fayetteville, AR (US)

(73) Assignee: Wildgame Innovations, LLC, Broussard, LA (US)

(21) Appl. No.: 13/966,660

(22) Filed: Aug. 14, 2013

Related U.S. Application Data
(60) Provisional application No. 61/683,641, filed on Aug. 15, 2012.

(51) Int. Cl. A01M 31/00

(52) U.S. Cl. CPC A01M 31/004
USPC 446/202

(57) ABSTRACT

A game call extension apparatus including an extension means and an attachment means operatively connected to and in fluid communication with one another. The attachment means is configured to secure an end of a mouth-controlled game call therein. The extension means may be a tubular conduit. A distal end of the tubular conduit may be operatively connected to the attachment means. A proximal end of the tubular conduit may be placed near a caller and the attachment means with a game call secured therein may be placed at a call emitting location that is remote from the location of the caller. The caller may cause the game call to emit a sound to attract a target animal to the call emitting location by blowing air into or inhaling air from the proximal end of the tubular conduit.

### CROSS-REFERENCE TO RELATED APPLICATIONS

This application claims the benefit of and priority to U.S. Provisional Patent Application No. 61/683,641, filed Aug. 15, 2012, which is incorporated herein by reference.

### BRIEF DESCRIPTION OF THE DRAWINGS

FIG. 1 is a perspective view of a game call extension apparatus of the present invention.

FIG. 2 is a perspective view of the game call extension apparatus with a game call operatively connected thereto.

FIG. 3A is a cross-sectional exploded view of the game call extension apparatus with a mouthpiece end of a game call operatively connected thereto.

FIG. 3B is a cross-sectional exploded view of the game call extension apparatus with a bell end of a game call operatively connected thereto.

FIG. 4 is a cross-sectional exploded view of an alternate embodiment of the game call extension apparatus with a game call operatively connected thereto.

FIG. 5 is a bottom view of an attachment means of the game call extension apparatus.

FIG. 6 is a schematic illustration of the game call extension apparatus situated for use by a caller positioned in a tree stand.

FIG. 7 is a schematic illustration of the game call extension apparatus situated for use by a caller positioned in a ground blind.

FIG. 8 is a schematic illustration of the game call extension apparatus configured for use with more than one game call.

### DETAILED DESCRIPTION OF THE PREFERRED EMBODIMENTS

The game call extension apparatus of the present invention extends the distance between the caller and a mouth-controlled game call used to simulate the sounds made by a deer, moose, duck, goose, turkey, elk, or other animal. The distance is extended to achieve a spatial separation between the caller and the call through the placement of an extension means capable of communicating the breath exhaled by the caller to the call in order to cause activation of the sound producing means (e.g., vibrating reed or reeds) within the call and the emission of the produced sound from the call. The extension means may include a conduit capable of fluid (e.g., air) communication between the caller and the call. The conduit can be various lengths and sizes. The conduit may be attached directly to the call or to a game call attachment means to which the call is operatively affixed. The conduit may be a flexible tube.

The attachment means may be weighted to facilitate positioning thereof. For example, the attachment means with detachably affixed call may be lowered from an elevated position (e.g., a tree stand where the caller is located) to a position on or near the ground. Lowering may be accomplished by running out the extension means until the attachment means and affixed call are at the desired position. The weighted attachment means is also useful to stabilize the attachment means and affixed call when placed on or above the ground. The attachment means may be in the form of an animal decoy designed to attract the targeted animal.

The game call extension apparatus of the present invention may also include a securing means. The securing means may secure the apparatus to an object such as a tree, a ground stake, or other support structure. The securing means may secure the extension means or other component of the apparatus to the tree, stake, or support structure. The securing means may be loops, straps, Velcro, zip ties, cable, screws, or other similar devices. The securing means preferably should not reduce, restrict, or diminish the flow of air through the extension means if at all possible. However, it is to be understood that some reduction, restriction, or diminishment of air flow may occur so long as it does not result in significant distortion or interruption of the emission of sound from the call.

The attachment means may be constructed to operatively secure a variety of mouth-controlled game calls. The game calls may be detachably affixed to the attachment means. Fixation means may vary. For example, the attachment means may contain an interface capable of operatively mating with a variety of game calls. For example, the interface may operatively mate with the barrel end of the game calls containing the mouth piece. In an alternate configuration, the interface may operatively mate with the bell end of the game calls for inhale use in freezing temperatures. Other mating means may be employed. For example, the game call (e.g., the barrel end with the mouth piece) may operatively mate with the interface by reciprocal shapes of the game call mouthpiece and the interface.

The attachment means may include a precision-tuned air chamber. The chamber may contain a tuned air-release opening or hole. The opening is designed to permit the escape of a certain amount of the blown air in order to prevent the game call from being overpowered by the blast of air being communicated through the extension means to the game call within the attachment means. In other words, the air-release opening acts as a pressure release to ensure that the game call is not rendered inoperable by the force of the air being transmitted through the extension means to the game call.

The game call extension apparatus of the present invention achieves spatial separation of the call from the caller. The distance separating the caller from the call may vary depending on the length of the extension means. The separation distance may be anywhere from one foot to several feet depending on the length of the extension means. For example, the attachment means with detachably affixed game call may be dangled from an elevated platform (such as a tree) and lowered to ground level. Alternatively, the extension means may be rolled or laid out on the ground such that the attachment means with affixed game call are separated from the caller who may be located in a ground blind or other concealed ground location. Use of the game call extension apparatus of the present invention enables the sound produced by the game call to be heard at a distance and location remote from the caller. Accordingly, the attention of the targeted animal is not drawn to the location of the caller but instead is directed to the location of the call. Separating the call from the caller reduces the likelihood that the targeted animal will detect the presence and location of the caller resulting in the targeted animal being alerted or spooked and fleeing the area.

It is to be understood that different and varying embodiments of the game call extension apparatus of the present invention may achieve the feature of spatial separation between the call and the caller. One such embodiment is shown in the appended figures and is described below.

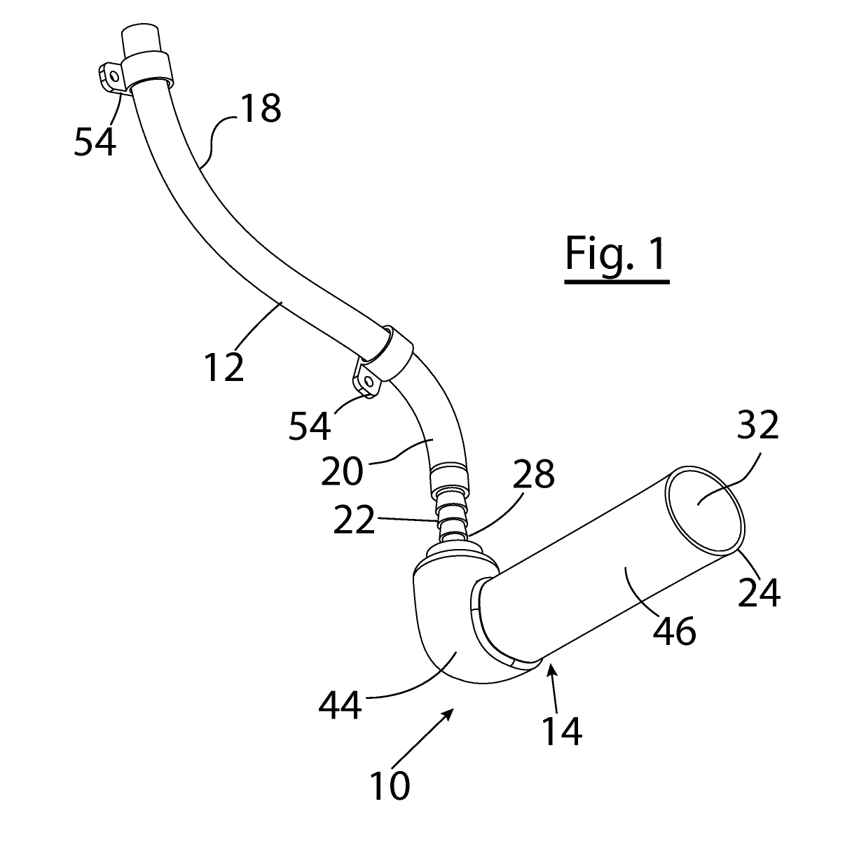

With reference to FIG. 1, game call extension apparatus 10 may include extension means 12 and attachment means 14. Extension means 12 may be a conduit such as a flexible tube. The size and length of extension means 12 may vary. For example, extension means 12 may be up to 100 feet in length or more, depending on the intended use. Extension means 12 may also be in the range of 10 feet to 50 feet in length. Extension means 12 may have an inner diameter of ⅜ inch and an outer diameter of ½ inch. It is to be understood that the inner and outer diameter of extension means 12 may be various sizes depending upon the characteristics (e.g., reed size) of the game call used with extension apparatus 10. For game calls having larger reeds, extension means 12 may have a larger diameter. For game calls having smaller reeds, extension means 12 may have a smaller diameter. Extension means 12 may be made of any type of relatively flexible material such as plastic, vinyl, PVC, or the like. While some flexibility is preferred, it is to be understood that extension means 12 may be constructed of a relatively rigid material.

Again with reference to FIG. 1, extension means 12 may have proximal end 18 and distal end 20. Proximal end 18 may function as the air receiving end whereby the caller blows air into extension means 12. Distal end 20 may function as the air exiting end transmitting blown air to the game call.

As shown in FIG. 1, attachment means 14 may include extension end 22 and attachment end 24. Extension end 22 acts as the attachment point for distal end 20 of extension means 12. In one embodiment, extension end 22 may include barb adaptor end 28 that receives and secures distal end 20 of extension means 12. Distal end 20 may slip over barb adaptor end 28 to operatively connect extension means 12 to attachment means 14.

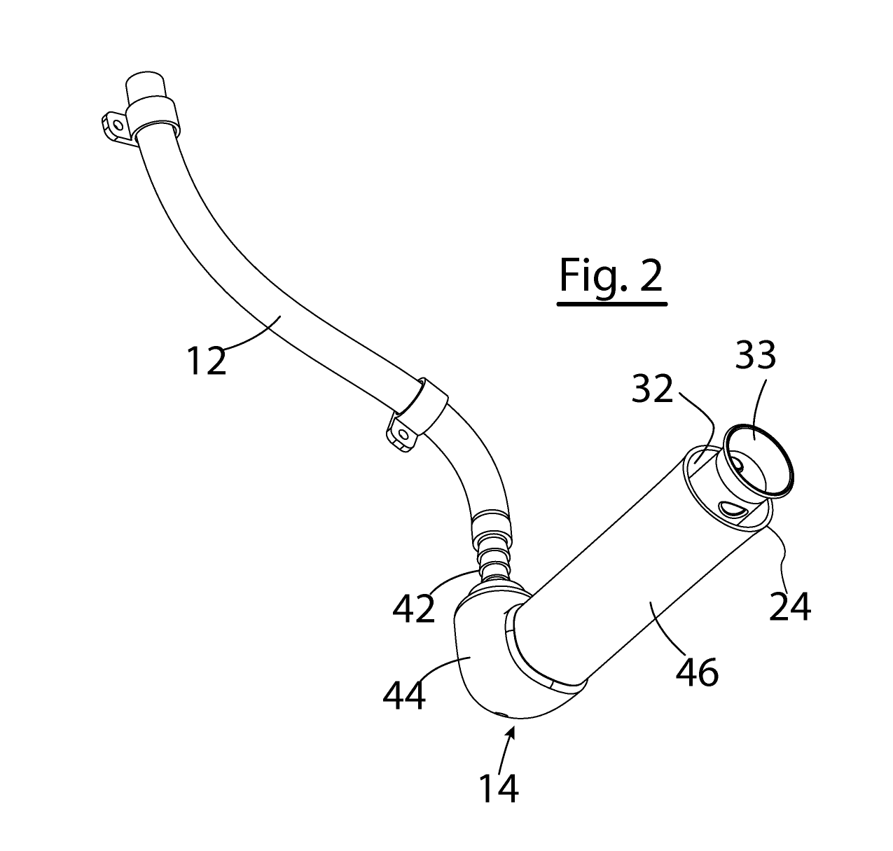

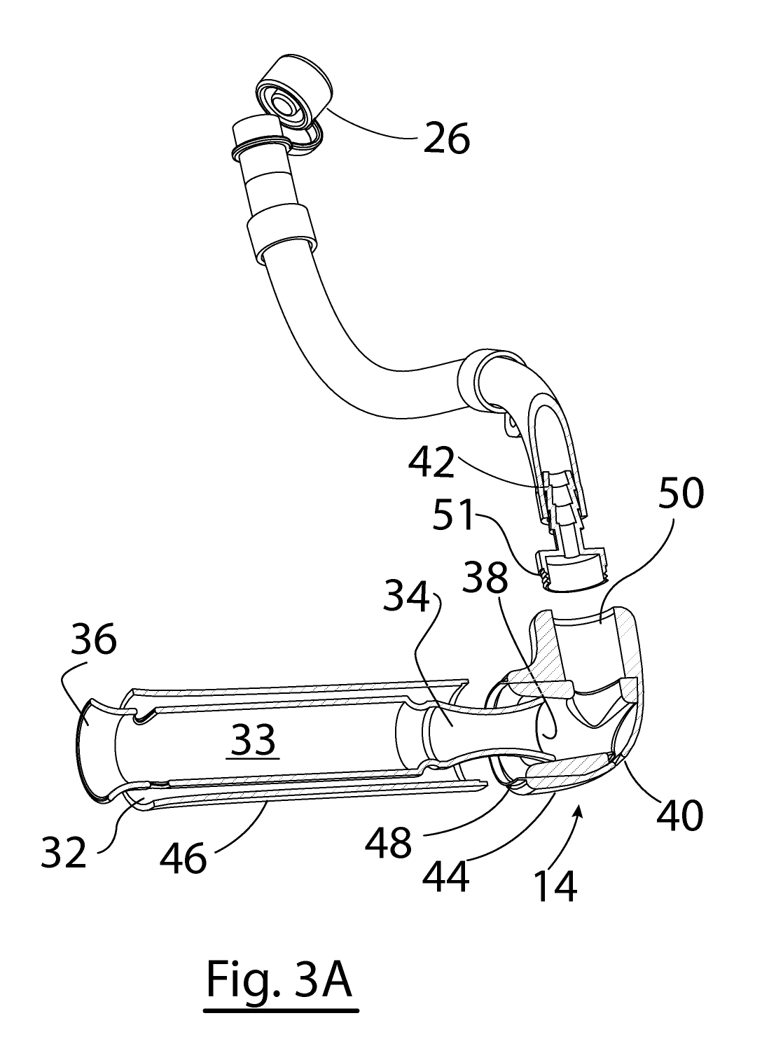

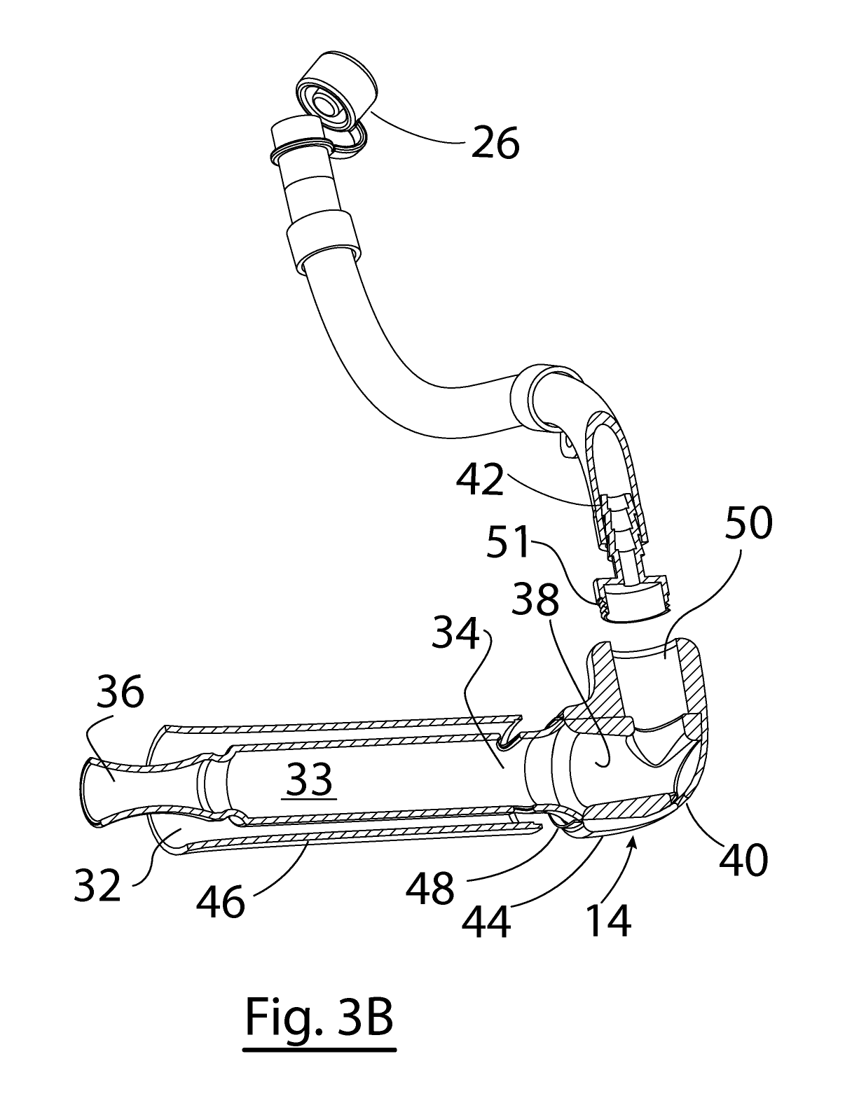

With reference now to FIGS. 1-3B, attachment end 24 of attachment means 14 may be provided with attachment opening 32 for entry of a game call, such as game call 33. Game call 33 may be a tube-type mouth-blown game call with mouthpiece end 34 and bell end 36. Game call 33 may be 6 to 12 inches in length. Mouthpiece end 34 may be detachably or permanently affixed within the interior of attachment means 14 as shown in FIG. 3A. Attachment means 14 may include internal interface 38 that receives mouthpiece end 34 of game call 33 and secures game call 33 at least partially within attachment means 14. Alternatively, bell end 36 of game call 33 may be detachably or permanently affixed within the interior of attachment means 14 as shown in FIG. 3B. In this alternative, internal interface 38 may receive and secure bell end 36 of game call 33 at least partially within attachment means 14.

Internal interface 38 may detachably secure game call 33 within attachment means 14. Internal interface 38 may be configured such that it is capable of securing a variety of game calls 33. Alternatively, attachment means 14 may include two or more internal interfaces 38 having differing sizes and/or shapes such that internal interfaces 38 may be interchanged in order to secure different game calls 33 (or different ends of game calls) within attachment means 14.

In another alternative embodiment, internal interface 38 may permanently secure game call 33 within attachment means 14. For example, mouthpiece end 34 (or the external surface of mouthpiece end 34) could be glued to internal interface 38 or otherwise be permanently affixed thereto.

FIGS. 3A-5 show that attachment means 14 may contain air-release opening 40. Opening 40 provides access from the interior bore of attachment means 14 to the atmosphere. One or more openings 40 may be included in attachment means 14. Opening 40 serves to release air blown into attachment means 14 to prevent game call 33 from being overpowered by the blown air communicated into attachment means 14 and to game call 33. The size and number of openings 40 provided in attachment means 14 may depend on the size of attachment means 14, the volume of air capable of being communicated to the interior of attachment means 14, or the reed size of game call 33. For example, opening 40 may have a 3/16 inch diameter.

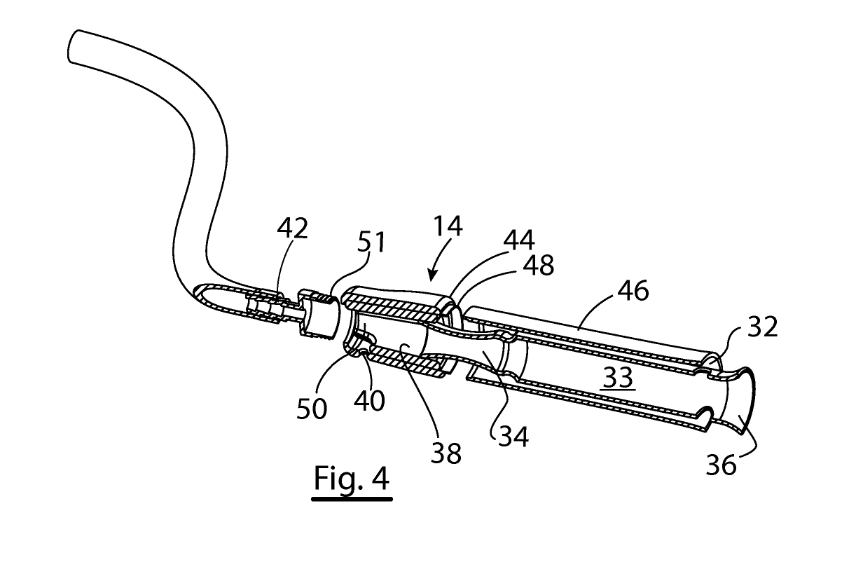

Attachment means 14 may be configured in a variety of shapes, sizes, and materials. Attachment means 14 may be configured as an L-shaped tubular member as illustrated in FIGS. 1 through 3B and 5. Alternatively, attachment means 14 may be configured as a straight tubular member as shown in FIG. 4. A caller may prefer to use the L-shaped configuration shown in FIGS. 1-3B and 5 in a tree stand, and the straight configuration shown in FIG. 4 in a ground blind or other position at or near ground level. Attachment means 14 may be made unitary or comprised of separate parts affixed together. Attachment means 14 may be made of a variety of durable materials such as metal, plastic, rubber, wood, composite, or other suitable materials.

In the embodiments shown in FIGS. 3A, 3B, and 4, attachment means 14 may comprise adaptor insert 42, air chamber 44, and game call housing 46. Air chamber 44 may be formed of PVC, polycarbonate, ABS, or any other durable material. Air chamber 44 may have an inner diameter in the range of ¼ inch to 2 inches depending on the reed size of game call 33. Air chamber 44 may be elbow-shaped as shown in FIGS. 3A and 3B in order to form an L-shaped attachment means 14. Alternatively, air chamber 44 may be a straight tubular member as shown in FIG. 4 to form a straight attachment means 14. Game call housing 46 may be formed of a steel pipe, PVC, polycarbonate, ABS, or any other durable material. An end of game call housing 46 may be glued, slipped over or into, or threadedly attached to receiver end 48 of air chamber 44. Game call housing 46 may have an outer diameter in the range of 1 inch to 3 inches, and an inner diameter in the range of ½ inch to 2½ inches. Game call housing 46 may have a length in the range of 6 to 12 inches. Air chamber 44 may also have air chamber threaded end 50 to receive adaptor insert 42. Air chamber threaded end 50 may be formed with internal threads for threadedly attaching to adaptor threaded end 51 of adaptor insert 42. Adaptor insert 42 may have an internal diameter in the range of ¼ inch to 2 inches, and an outer diameter in the range of ¾ inch to 2½ inches, depending on the reed size of game call 33. Adaptor insert 42 may have barb adaptor end 28 having a diameter in the range of ⅜ inch to 2¼ inch, and adaptor threaded end 51 having a diameter of ½ inch.

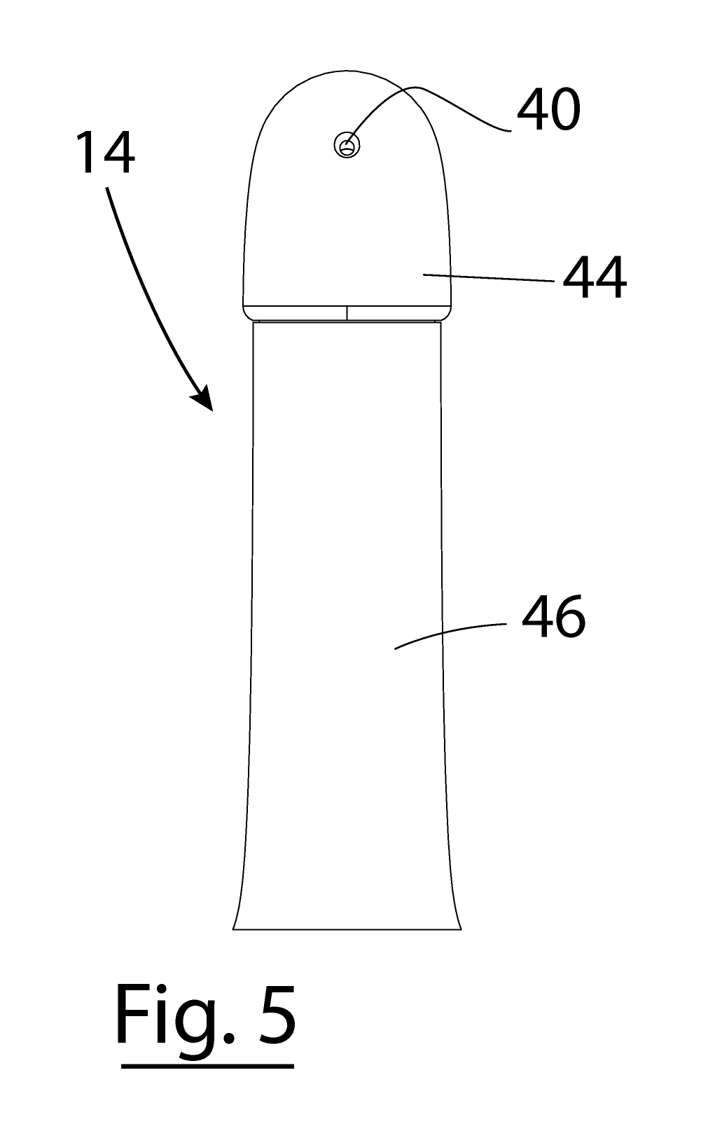

In the L-shaped configuration of attachment means 14, opening 40 may be positioned at the bottom of air chamber 44 as shown in FIG. 5. In one embodiment, opening 40 may align with a center axis running through game call housing 46. It is to be understood that alternate positions of opening 40 may be employed.

In one embodiment, extension means 12 may be formed of two or more separate sections sequentially attached to one another with an adaptor. This adaptor may have a design similar to adaptor insert 42.

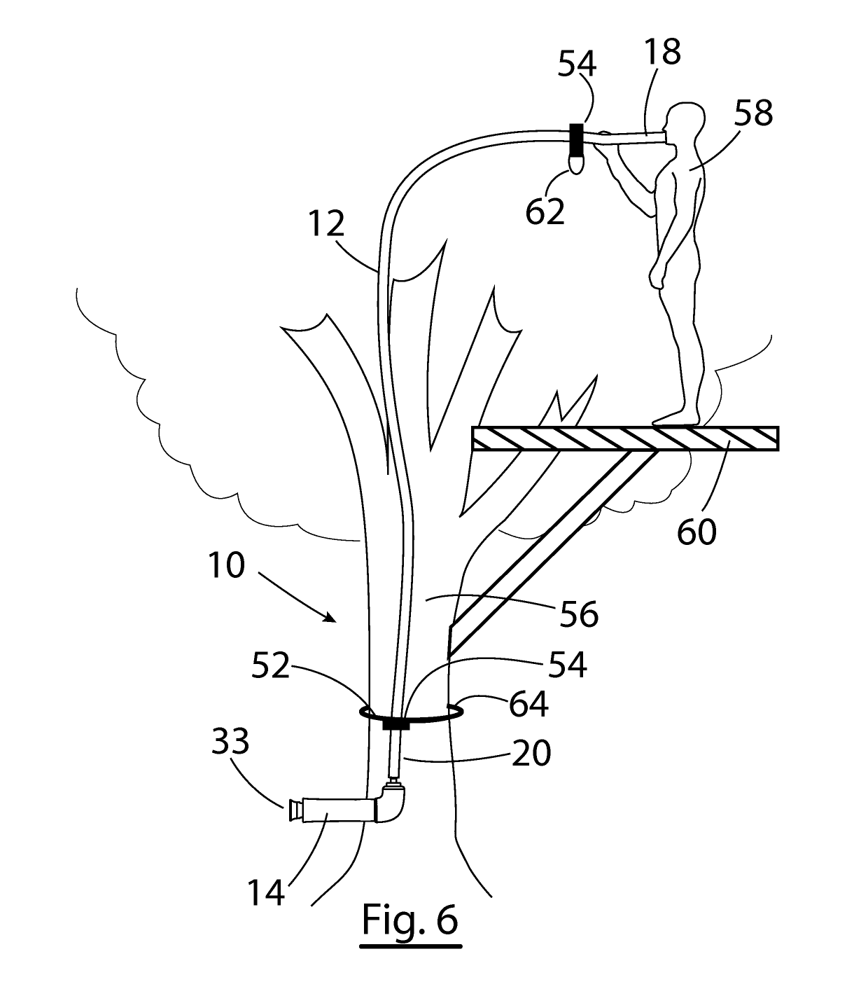

With reference to FIG. 6, game call extension apparatus 10 may include securing means 52 to attach apparatus 10 to a support structure. Securing means 52 may be a variety of devices for supporting apparatus 10 about a structure, such as a tree, ground blind, or a portion of a tree stand. For example, securing means 52 may include, but is not limited to, a tie, strap, cord, paracord, rope, cable, clamp, or other similar means to hold apparatus 10 against a support structure. Alternatively, securing means 52 may be a screw-type connector. One or more securing means 52 may be used with apparatus 10. In one embodiment, securing means 52 may be used to attach attachment means 14 with game call 33 to or through an animal decoy. In another embodiment, securing means 52 may be used to suspend attachment means 14 with game call 33 from a stake or other support structure capable of elevating attachment means 14 above the ground.

As seen in FIGS. 1, 2, and 6, securing means 52 may comprise one or more securing brackets 54 having a recess through which a zip tie, cord, rope, cable, or strap may be placed and wound around the supporting structure to secure game call extension apparatus 10. Alternatively, a nail, staple, screw, Velcro, or similar mounting device could be used in conjunction with securing bracket 54 to secure apparatus 10 to the support structure. Securing brackets 54 may be situated at any suitable location on extension means 12, such as near proximal end 18 and near distal end 20.

FIG. 6 shows game call extension apparatus 10 in an operable position about tree 56. Caller 58 is positioned in an elevated position on tree stand 60. Extension means 12 is run from tree stand 60 down to or near ground level to a position remote from caller 58. Proximal end 18 of extension means 12 is secured via a first zip tie 62 through first securing bracket 54 to a tree limb. Distal end 20 is secured via a second zip tie 64 through second securing bracket 54 to the base of tree 56. It is to be understood that screws, ropes, cords, or cables may be used instead of or in addition to first zip tie 62 and second zip tie 64.

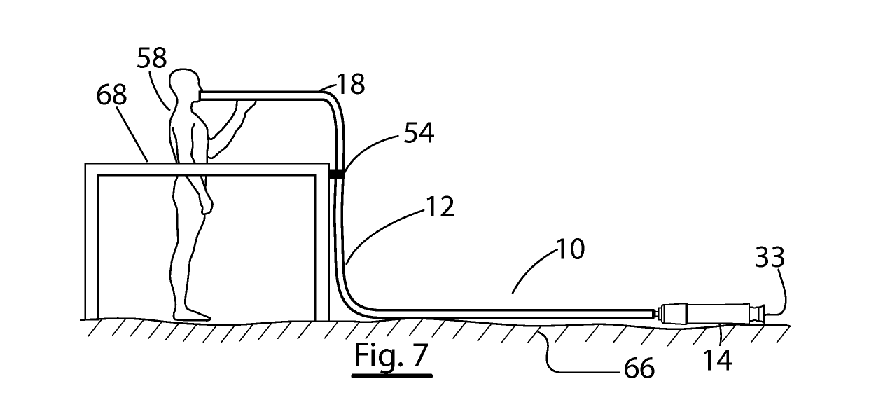

FIG. 7 shows apparatus 10 in operable position on the ground 66. Caller 58 is positioned in ground blind 68. Proximal end 18 of extension means 12 is secured to blind 68 via a zip tie, screw, rope, cord, or cable through first securing bracket 54. Extension means 12 is run along ground 66 to a position remote from ground blind 68.

Apparatus 10 is used by placing attachment means 14 with game call 33 operatively affixed therein in a location remote from the location of caller 58 and placing proximal end 18 of extension means 12 at or directly adjacent to the location of caller 58. To cause game call 33 to produce a sound to attract a targeted animal, caller 58 may place proximal end 18 at or in his or her mouth. In one embodiment, securing means 52 may be used to attach proximal end 18 to a nearby tree limb, a tree stand railing, a tree stand, or a blind in which caller 58 is located. Caller 58 blows air into proximal end 18. The blown air is forced from proximal end 18, through extension means 12 to distal end 20 where the air passes into the interior of attachment means 14 and to game call 33. The air is then forced into and through game call 33 to produce the animal sound at the location remote from caller 58. If a targeted animal is in hearing distance of the produced sound, the animal's attention will be directed to the location of the sound and away from caller 58 in the remote location. Thus, the chance of the targeted animal detecting the presence or location of caller 58 and being spooked (e.g., by sound, movement, odor) is reduced. And the chance that the targeted animal will be influenced by the sound to approach the vicinity of the area where attachment means 14 is positioned is increased.

In another embodiment, apparatus 10 may be configured as shown in FIG. 3B with bell end 36 of game call 33 secured within attachment means 14 such that caller 58 may produce sound through game call 33 by inhaling air from proximal end 18 of extension means 12. As caller 58 inhales air from extension means 12, air is sucked through game call 33 thereby producing a sound with game call 33 at the location of attachment means 14 that is remote from the location of caller 58. This configuration is useful in freezing temperatures where a possibility exists that air blown from the mouth of caller 58 through game call 33 in the configuration shown in FIG. 3A may lead to freezing of the reeds of game call 33. By using the configuration of FIG. 3B, caller 58 avoids the reed freezing possibility by forcing cold, dry air through game call 33.

Apparatus 10 and its various components may be formed of various colors, including colors intended to disguise apparatus 10 from a target animal.

With reference again to FIG. 3B, one embodiment of extension means 12 may include closure device 26 on its proximal end 18 and/or its distal end 20. If caller 58 wishes to leave apparatus 10 in a location over a period of time during which apparatus 10 will be unattended, caller 58 may engage closure device(s) 26 in order to seal proximal end 18 and/or distal end 20 such that no insects, debris, or other objects enter extension means 12.

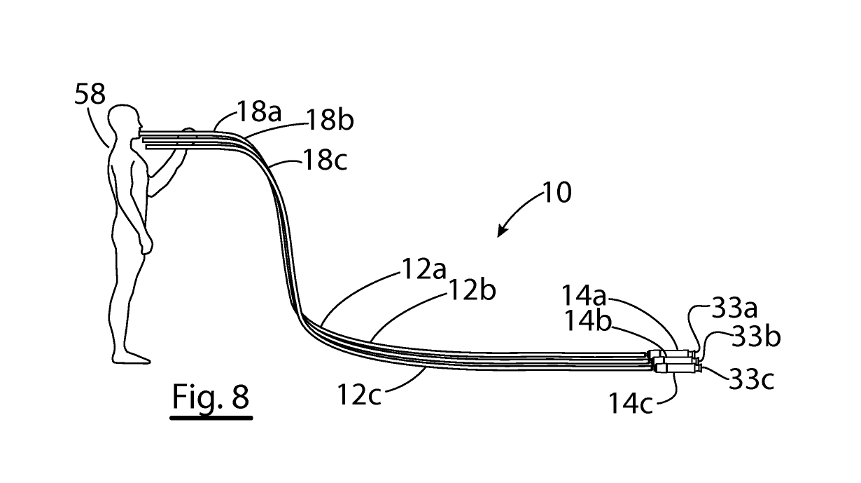

In yet another embodiment, apparatus 10 may be configured to simultaneously accommodate two or more separate game calls 33. For example, apparatus 10 may include two or more extension means 12 leading to two or more attachment means 14 securing two or more game calls 33. FIG. 8 illustrates one such embodiment. Apparatus 10 includes extension means 12A, 12B, and 12C, which may be formed of one structure having three extension means 12, three extension means 12 operatively connected together, three completely separate extension means 12, or any combination thereof. Proximal ends 18A, 18B, and 18C of each extension means 12A, 12B, and 12C may be positioned near caller 58. Game calls 33A, 33B, and 33C may be secured to attachment means 14A, 14B, and 14C, respectively. Game calls 33A, 33B, and 33C may each be a different type of game call. Caller 58 may blow air into proximal end 18A in order to produce sound with game call 33A. Similarly, caller 58 may blow air into proximal end 18B in order to produce sound with game call 33B, and may blow air into proximal end 18C in order to produce sound with game call 33C. In one embodiment, proximal ends 18A, 18B, and 18C may be marked or color-coded in order to allow caller 58 to distinguish among the game calls 33A, 33B, and 33C associated with each of proximal ends 18A, 18B, and 18C. In another embodiment, extension means 12A, 12B, and 12C may be formed separately and attachment means 14A, 14B, and 14C with attached game calls 33A, 33B, and 33C may be placed in locations separated by some distance from one another. The inhale configuration shown in FIG. 3B may be used in connection with this embodiment of apparatus 10 that is configured to accommodate two or more game calls 33.

While preferred embodiments of the present invention have been described, it is to be understood that the embodiments are illustrative only and that the scope of the invention is to be defined solely by the appended claims when accorded a full range of equivalents, many variations and modifications naturally occurring to those skilled in the art from a review hereof.

What is claimed is:

1. A game call extension apparatus comprising:
an extension means; and
an attachment means operatively connected to said extension means and being in fluid communication therewith, said attachment means configured to secure an end of a mouth-controlled game call therein.

2. The apparatus of claim 1, wherein said extension means comprises a flexible conduit.

3. The apparatus of claim 1, wherein said extension means includes one or more securing brackets.

4. The apparatus of claim 3, wherein said one or more securing brackets each includes an aperture for attachment of a support securing device.

5. The apparatus of claim 4, wherein said support securing device is selected from the group consisting of a zip-tie, a strap, a cord, a rope, a cable, a nail, a staple, a screw, and Velcro.

6. The apparatus of claim 1, wherein said attachment means comprises an adaptor for operatively engaging said extension means.

7. The apparatus of claim 1, wherein said attachment means includes one or more air-release openings.

8. The apparatus of claim 1, wherein said extension means includes a closure device configured to selectively seal a proximal end or a distal end of said extension means.

9. The apparatus of claim 1, further comprising a mouth-controlled game call, wherein an end of said game call is permanently affixed to said attachment means.

10. A game call extension apparatus comprising:
an extension means, said extension means being a tubular conduit having a proximal end and a distal end; and
an attachment means operatively connected to said distal end of said tubular conduit and being in fluid communication therewith, said attachment means being a tubular member including a game call housing and an air chamber, said game call housing and said air chamber configured to secure an end of a mouth-controlled game call therein.

11. The apparatus of claim 10, wherein said air chamber of said attachment means contains an internal interface configured to operatively secure an end of a mouth-controlled game call within said attachment means.

12. The apparatus of claim 11, further comprising a mouth-controlled game call, wherein an end of said game call is permanently affixed to said internal interface of said attachment means.

13. The apparatus of claim 11, further comprising a mouth-controlled game call, wherein an end of said game call is detachably affixed to said internal interface of said attachment means.

14. The apparatus of claim 10, wherein said air chamber comprises an elbow-shaped tubular member.

15. The apparatus of claim 10, wherein said air chamber comprises a straight tubular member.

16. The apparatus of claim 10, wherein said attachment means further comprises an adaptor interconnecting said distal end of said tubular conduit to an end of said air chamber of said attachment means.

17. The apparatus of claim 10, where said attachment means contains an air-release opening in said air chamber.

18. The apparatus of claim 10, wherein said extension means includes a closure device configured to selectively seal said proximal end or said distal end of said extension means.

19. The apparatus of claim 10, further comprising:
a second extension means being a second tubular conduit having a proximal end and a distal end, said proximal end of said second tubular conduit operatively connected to said proximal end of said tubular conduit; and
a second attachment means operatively connected to said distal end of said second tubular conduit and being in fluid communication therewith, said second attachment means being a second tubular member including a second game call housing and a second air chamber, said second game call housing and said second air chamber configured to secure an end of a second mouth-controlled game call therein.

20. A method of calling a target animal, comprising the steps of:
a) providing a game call extension apparatus, said apparatus comprising an extension means, said extension means being a tubular conduit having a proximal end and a distal end; an attachment means operatively connected to said distal end of said tubular conduit and being in fluid communication therewith, said attachment means being a tubular member including a game call housing and an air chamber;
b) securing an end of a mouth-controlled game call to said attachment means of said apparatus such that said end of said game call is in fluid communication with said air chamber of said attachment means and said tubular conduit;
c) determining a calling location;
d) determining a call emitting location, said call emitting location being remote from said calling location;
e) situating said apparatus so that said attachment means and said game call are positioned at said call emitting location and said proximal end of said tubular conduit is positioned at said calling location; and
f) causing said game call to emit a sound to attract said target animal to said call emitting location by blowing air into or inhaling air from said proximal end of said tubular conduit.

21. The method of claim 20, wherein said call emitting location is at or near a ground level and said calling location is elevated above said ground level.

22. The method of claim 20, wherein said call emitting location and said calling location are each at or near a ground level.

23. The method of claim 20, further comprising the step of:
e1) securing said tubular conduit to a support structure.

24. The method of claim 20, wherein in step (b) a mouthpiece end of a mouth-controlled game call is secured to said attachment means of said apparatus such that said mouthpiece end of said game call is in fluid communication with said air chamber of said attachment means and said tubular conduit; and wherein step (f) comprises causing said game call to emit a sound to attract said target animal to said call emitting location by blowing air into said proximal end of said tubular conduit.

25. The method of claim 20, wherein in step (b) a bell end of a mouth-controlled game call is secured to said attachment means of said apparatus such that said bell end of said game call is in fluid communication with said air chamber of said attachment means and said tubular conduit; and wherein step (f) comprises causing said game call to emit a sound to attract said target animal to said call emitting location by inhaling air from said proximal end of said tubular conduit.
